(19) United States
(12) Patent Application Publication
(10) Pub. No.: US 2025/0387958 A1
(43) Pub. Date: Dec. 25, 2025

(54) AUTOMATED PANEL CONSTRUCTION SYSTEM

(71) Applicant: Harper Engineering Co., Renton, WA (US)

(72) Inventor: David Chadwell, Renton, WA (US)

(21) Appl. No.: 19/244,478

(22) Filed: Jun. 20, 2025

Related U.S. Application Data
(60) Provisional application No. 63/662,309, filed on Jun. 20, 2024.

(51) Int. Cl. B29C 45/14; B29K 101/12; B29L 31/30

(52) U.S. Cl. CPC B29C 45/14065; B29C 2045/14147; B29K 2101/12; B29L 2031/30

(57) ABSTRACT

A method of manufacturing a panel is disclosed, which may include extruding a plastic material and injecting the extruded plastic material into at least one of an edge of the panel and an insert cavity of the panel. A panel construction machine is also disclosed, which may include a plastic extruder configured to extrude a plastic material and an injection molding nozzle configured to inject the extruded plastic material into at least one of an edge of a panel and an insert cavity of the panel.

### BACKGROUND

### Technical Field

The present disclosure relates generally to panel construction systems, specifically automated panel construction systems for panels including inserts and finished edges.

### Description of the Related Art

Panels of vehicles, such as aircraft, may require inserts, such as threaded inserts, which enable coupling of the panels to other panels or components of the vehicle. Such panels commonly comprise a number of layers, such as in, for example, composite panels. Installation of such inserts into such panels and machining of through holes therethrough may require a number of machines which impede manufacturing efficiencies and may increase manpower required during such manufacturing processes. For example, adhesives are commonly applied to inserts and the surrounding cavities, and commonly require significant curing times. In another example, edges of at least one layer of composite panels may be rough after machining, and may require manual application of a filler to enable the edges to be machined into a smooth shape. A solution for automating and expediting panel construction could provide significant improvements to the cost and timeliness of panel construction.

### BRIEF SUMMARY

Embodiments described herein include a method of manufacturing a panel and related panel construction machinery that provide improved efficiency in the manufacture of the panel and which may provide a reduced cost in doing so.

A method of manufacturing a panel according to an example embodiment may be summarized as including extruding a plastic material and injecting the extruded plastic material into at least one of an edge of the panel and an insert cavity of the panel.

In some example embodiments, the extruded plastic material may surround an insert in the insert cavity and the insert may be potted in the panel by the extruded plastic material when the extruded plastic material is injected into the insert cavity of the panel. The insert may be releasably gripped by a deployable pin holding device during injecting of the extruded plastic material into the insert cavity of the panel. The deployable pin holding device may extend from a pin housing and may grip the insert prior to injection of the extruded plastic material into the insert cavity of the panel. The deployable pin may release the grip on the insert following completion of the injection of the extruded plastic material into the insert cavity and may retract to the pin housing. The deployable pin holding device may include external threads configured to threadably couple to internal threads of the insert when the deployable pin holding device grips the insert.

In some embodiments, the pin housing may further include an injection molding aperture configured such that the injection molding nozzle passes through the injection molding aperture prior to injection of the extruded plastic material within the insert cavity.

In some example embodiments, the edge of the panel may be defined by a machining device prior to injection of the extruded plastic material onto the edge of the panel. A shape profile of the panel may be defined by a machining device following injection of the extruded plastic material onto the edge of the panel. Similarly, the insert cavity may be machined into the panel prior to injection of the extruded plastic material into the insert cavity of the panel.

The panel construction machine described herein may comprise a turret having a plurality of insert holding devices. The turret may be configured such that the extruded plastic material flows from the plastic extruder and through a selected insert holding device of the plurality of insert holding devices. The plurality of insert holding devices may be configured to collectively hold a plurality of inserts.

Embodiments described herein further describe a panel construction machine configured to perform the method described herein.

Embodiments described herein further describe a panel manufactured by the method described herein.

Although aspects of some of the embodiments disclosed herein are described in the context of manufacturing a panel of a vehicle, it is appreciated that aspects may be utilized in a variety of applications to manufacture various products.

### BRIEF DESCRIPTION OF THE SEVERAL VIEWS OF THE DRAWINGS

FIG. 1 shows a perspective view of an exemplary panel, which may be manufactured according to embodiments described herein.

FIG. 2 shows a schematic view of a panel construction system according to an example embodiment described herein.

FIG. 3 shows a perspective view of a blank panel following a preliminary machining process.

FIG. 4 shows a cross-sectional view of a deployable pin of an insert holding device coupled to an insert in a cavity prior to injection of extruded plastic material.

FIG. 5 shows a cross-sectional view of the deployable pin of the insert holding device coupled to the insert in the cavity of FIG. 4 during injection of the extruded plastic material.

FIG. 6 shows a cross-sectional view of the deployable pin withdrawn in the insert holding device and the insert in the cavity of FIGS. 4 and 5 following injection of extruded plastic material.

FIG. 7 shows a cross-sectional view of an insert holding device prior to injection of extruded plastic material into an edge of a panel.

FIG. 8 shows a cross-sectional view the insert holding device of FIG. 7 during injection of extruded plastic material into the edge of the panel.

FIG. 9 shows a plan view of a multi-outlet turret according to an example embodiment.

FIG. 10 shows a flow chart of a method of manufacturing a panel.

### DETAILED DESCRIPTION

In the following description, certain specific details are set forth in order to provide a thorough understanding of various disclosed embodiments. However, one skilled in the relevant art will recognize that embodiments may be practiced without one or more of these specific details. In other instances, well-known structures and techniques associated with panel construction systems may not be shown or described in detail to avoid unnecessarily obscuring descriptions of the embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

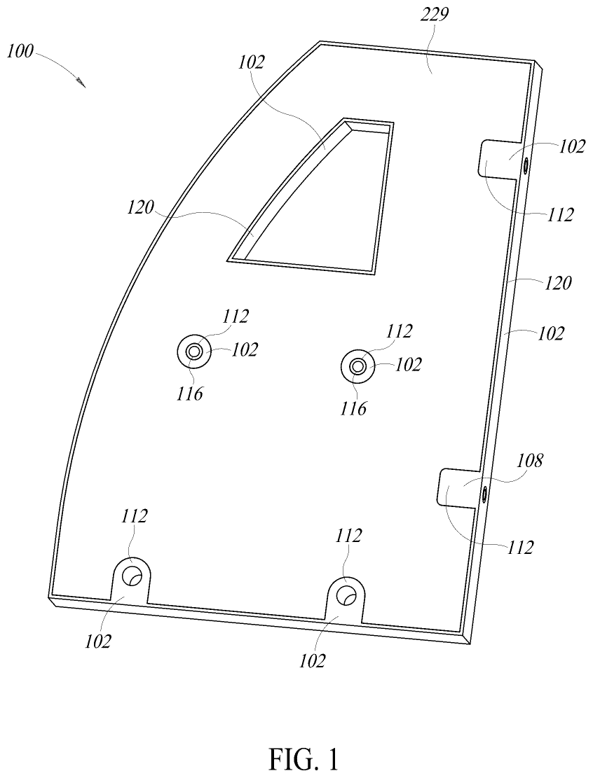

FIG. 1 shows a perspective view of a panel 100, which may be used as part of a vehicle, such as aircraft, or any appropriate structure. The panel 100 may be a composite panel, such that the panel 100 includes a number of layers. For example, the panel 100 may include fiberglass outer layers with a honeycomb structure therebetween. The construction of the panel may additionally or alternatively include any other suitable materials.

As seen in the FIG. 1, the panel 100 may include an extruded plastic material 102. The extruded plastic material 102 may be a thermoplastic material. The extruded plastic material may be implemented as edge-fill material and/or potting material. The extruded plastic material may fill cavities 112 in the panel 100. In some example embodiments, the cavities 112 may extend entirely through the panel 100. In some example embodiments, the cavities 112 may only extend partially through the panel 100. In some cavities 112, an insert 116 may be positioned at least partially within the extruded plastic material. The inserts 116 may be any suitable insert, such as threaded inserts, including inserts made according to NAS standards. Any number of desired inserts 116 may be included in the panel 100. The extruded plastic material may also fill an edge 120 of the panel 100.

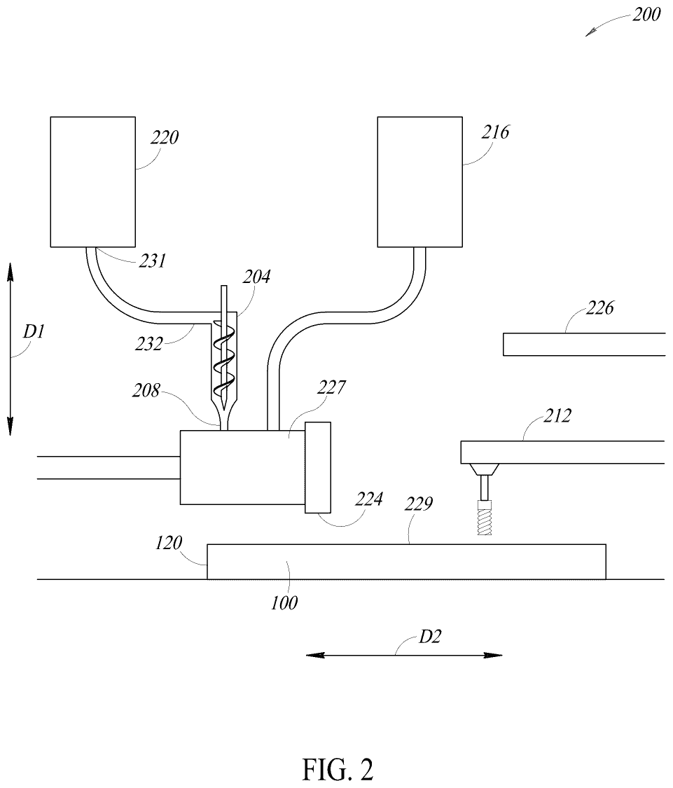

FIG. 2 shows a schematic view of a panel construction machine 200 configured to manufacture a panel, such as the panel 100. The panel construction machine 200 may be configured to perform automated construction of the panel 100, and may reduce or eliminate manpower needed to manufacture the panel 100. The panel construction machine 200 may include any of at least one plastic extruder 204, an injection molding nozzle 208, at least one machining device 212, a vibratory hopper 216, a nurdle hopper 220, at least one insert holding device 224, and a multi-outlet turret 227. In some embodiments, the panel construction machine 200 may include a panel cutter 226.

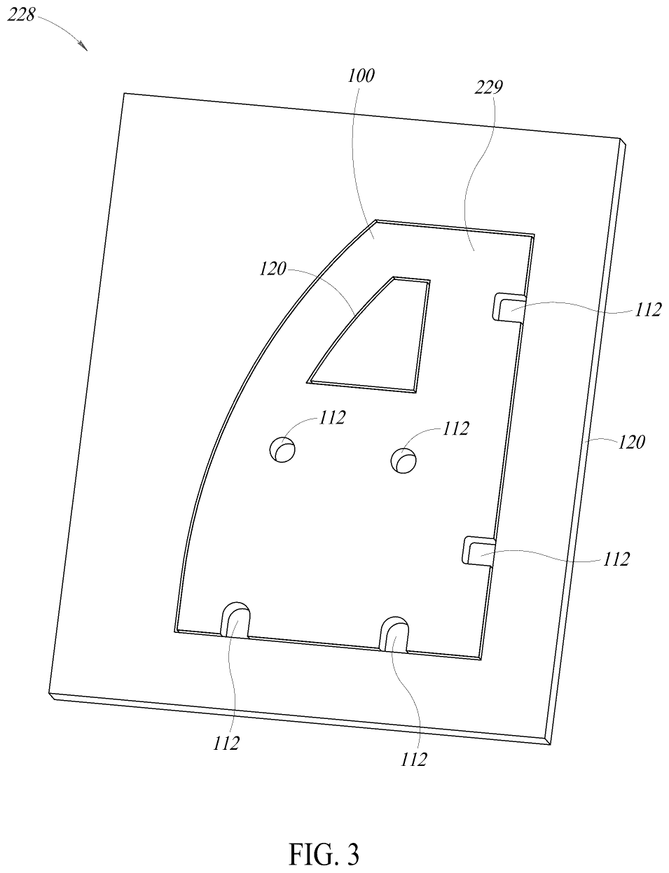

The machining device 212 may be configured to machine the panel 100. In some embodiments, the machining device 212 may be a mill. The machining device 212 may be configured to machine through the entirety of the panel 100. A machining operation performed by the machining device 212 may be performed on a blank panel 228 to machine part shapes and cavities 112 into the panel 100. The panel 100 after an exemplary preliminary machining operation is shown in FIG. 3.

The machining device 212 may also be configured to machine the panel 100 following completion of application of the extruded plastic material 102. For example, the machining device 212 may be configured to machine the extruded plastic material 102 to create smooth and/or uniform edges in the panel 100. Additionally or alternatively, the machining device 212 may be configured to machine the extruded plastic material 102 to create a surface level with a face 229 of the panel 100. Further abilities of the machining device 212 may include machining through-holes in the extruded plastic material 102.

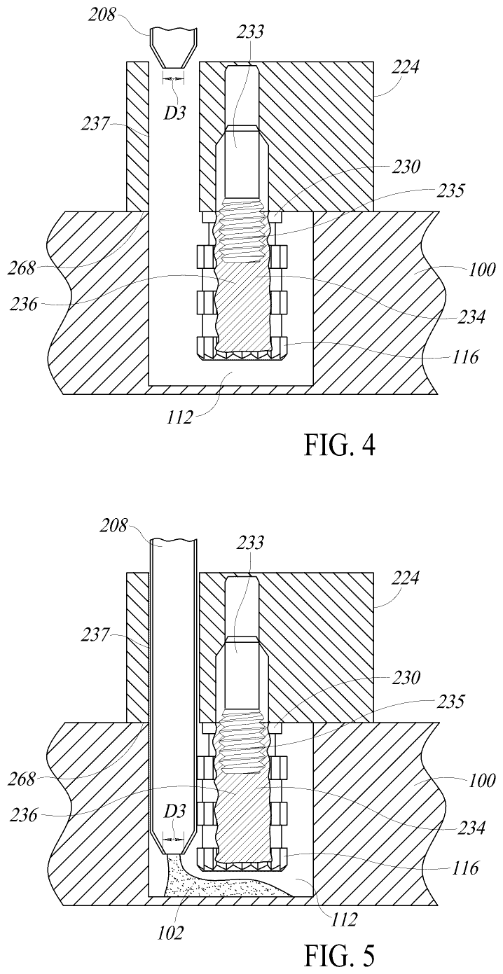

The vibratory hopper 216, which is shown in FIG. 2, may be configured to hold the inserts 116 therein prior to insertion of the inserts 116 in the panel 100. During operation of the vibratory hopper 216 (i.e., when vibrating), the vibratory hopper 216 may be configured to transport the inserts 116 to the insert holding device 224. The vibratory hopper 216 may be configured such that each insert 116 is delivered to the insert holding device 224 orientated in the same direction. In other words, a first side 230 of each insert 116 may face the insert holding device 224 upon delivery, as shown in FIGS. 4 and 5.

Returning to FIG. 2, the nurdle hopper 220 may be configured to hold thermoplastic nurdles therein. An outlet 231 of the nurdle hopper 220 may be coupled to an inlet 232 of the plastic extruder 204. The outlet of the nurdle hopper 220 may be configured such that only a desired amount of thermoplastic nurdles is able to pass therethrough during a specified timeframe.

The plastic extruder 204 may be configured to extrude the thermoplastic nurdles into the extruded plastic material 102. Such an extrusion process may occur by way of compression of the thermoplastic nurdles in the plastic extruder 204. Such an extrusion process may be assisted by the application of heat thereto during compression. The extruded plastic material 102 may then be used as the edge-fill in material and/or the potting material. The plastic extruder 204 may be a screw extruder.

The injection molding nozzle 208 may be configured to receive the extruded plastic material from the plastic extruder 204 and to inject the extruded plastic material 102 into any of an edge 120 of the panel 100 or a cavity 112 of the panel 100. The injection molding nozzle 208 may be configured to inject the extruded plastic material into the cavity 112 of the panel 100 when an insert 116 is present in the cavity 112. The injection molding nozzle 208 may be configured to selectively travel in any of a vertical direction D1 and/or a horizontal direction D2, such that the injection molding nozzle 208 may be selectively inserted into and withdrawn from the cavities 112 of the panel 100 and edges 120 of the panel 100 and may be moved to different positions on the panel 100. The injection molding nozzle 208 may be selectively inserted into and withdrawn from the cavity 120 and edges 120 of the panel 100 at different depths, such that the injection molding nozzle 208 may inject the extruded plastic material 102 at any desired depth. For example, the injection molding nozzle 208 is shown as being positioned at varying depths in each of FIGS. 4-6. In some embodiments, the panel construction machine 200 may include a plurality of injection molding nozzles 208. In some embodiments, each injection molding nozzle of the plurality of injection molding nozzles 208 may include a different nozzle diameter D3.

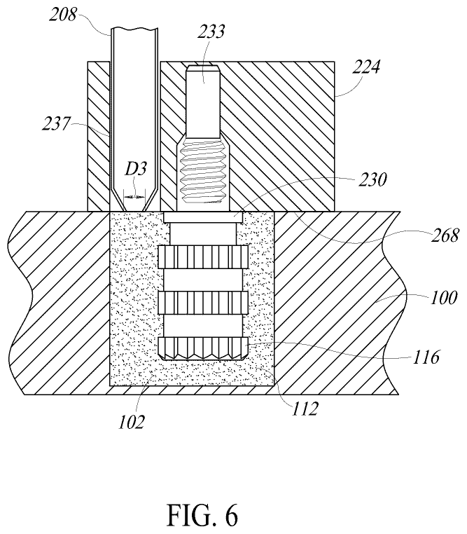

The insert holding device 224, which may also be referred to as the pin housing, is most clearly shown in FIGS. 4-8. The insert holding device may include a deployable pin 233. The deployable pin 233 may be configured to releasably grip the insert 116, as shown in FIGS. 4-6. The deployable pin 233 may be deployed from the insert holding device 224 such that the deployable pin 233 extends from the insert holding device 224. Following release of the insert 116 within the cavity 112, as shown in FIG. 6, the deployable pin 233 may be withdrawn into the insert holding device 224.

The deployable pin 233 may be configured to grip an internal face 234 of the insert 116. In some embodiments, the deployable pin 233 may include external threads 235 configured to threadably couple to internal threads 236 of the insert 116. In such embodiments, the deployable pin 233 may rotate during deployment from the insert holding device 224, such that the deployable pin 233 may engage the internal threads 236 of the insert 116 during deployment. The deployable pin 233 may be deployed before or during injection of the extruded plastic material into the cavity 112 of the panel 100. The deployable pin 233 may alternatively grip the internal face 234 of the insert 116 by alternative manners, such as by friction fitting.

The insert holding device 224 may include an injection molding aperture 237 configured to enable the injection molding nozzle 208 to extend therethrough. For example, when the injection molding nozzle 208 is extended in the vertical direction D1 in the example embodiment shown in FIGS. 4-6, the injection molding nozzle 208 extends through the injection molding aperture 237. When the injection molding nozzle 208 extends through the injection molding aperture 237, the extruded plastic material 102 may flow through the injection molding nozzle 208. The extruded plastic material 102 may flow from the injection molding nozzle 208 into any of the cavity 112 of the panel 100 or the edge 120 of the panel 100. In other words, the extruded plastic material 102 may flow out of the injection molding nozzle 208, which may extend through the injection molding aperture 237, and into a desired location in the panel 100. The injection molding aperture 237 may be configured such that extruded plastic material 102 may flow therethrough simultaneously with the deployable pin 233 being coupled to the insert 116. In such embodiments, the injection molding aperture 237 may be spaced at a distance away from the deployable pin 233 such that the injection molding aperture 237 is not positioned coincidentally with the insert 116 during operation.

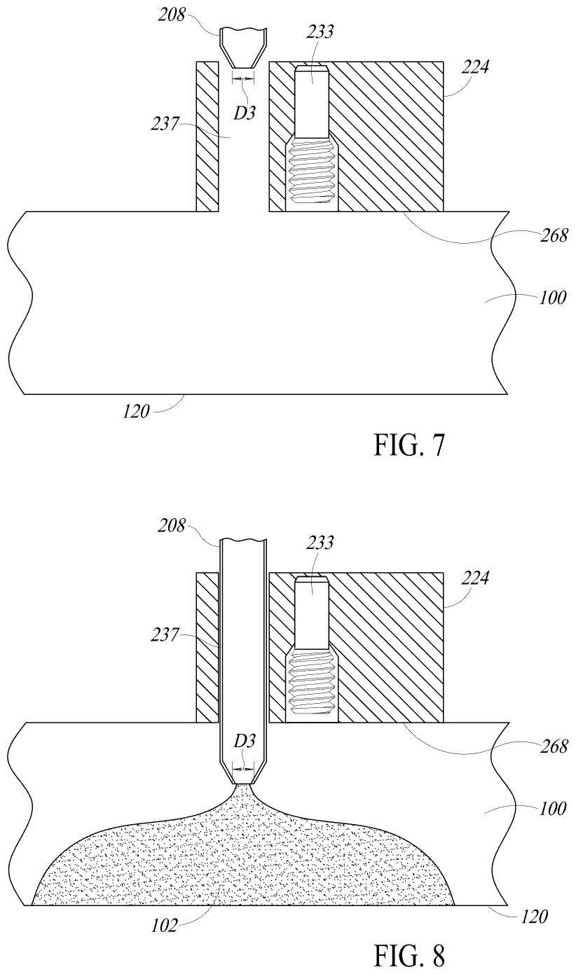

It should be understood that the flow of the extruded plastic material 102 may still occur in operations in which the deployable pin 233 is not coupled to the insert 116. For example, such a flow may occur during filling of an edge portion 120 of the panel 100, when no insert 116 is included therein, as shown in FIGS. 7 and 8. In such configurations, the deployable pin 233 may not be deployed from the insert holding device 224, and the injection molding nozzle 208 may extend through the injection molding aperture. In some embodiments, at least one insert holding device 224 may not include a deployable pin 233 to grip an insert 116 and may only be configured to include an injection molding aperture 237 configured to enable the injection molding nozzle 208 to extend therethrough. In some embodiments, at least one insert holding device 224 may be configured such that the injection molding nozzle 208 directly injects the extruded plastic material 102 without the use of an injection molding aperture 237. For example, the injection molding nozzle 208 may extend adjacent to the respective insert holding device 224. In such embodiments, the injection molding nozzle 208 may be free to extend to the cavity 112 or the edge 120 of the panel 100 without interaction with the at least one insert holding device 224. In some embodiments, the injection molding nozzle 208 may be configured to travel to various positions adjacent to the panel 100 independently of any movement of the insert holding device 224.

In some embodiments, the insert holding device 224 may be configured such that the deployable pin 233 extends from the insert holding device 224 in the vertical direction D1. In some embodiments, the insert holding device 224 may be configured such that the deployable pin 233 extends from the insert holding device 224 in the horizontal direction D2. It should be understood that the injection molding aperture 237 may be configured to enable the extruded plastic material 102 to flow out of the insert holding device 224 in any of the vertical direction D1, as shown throughout the figures, or the horizontal direction D2.

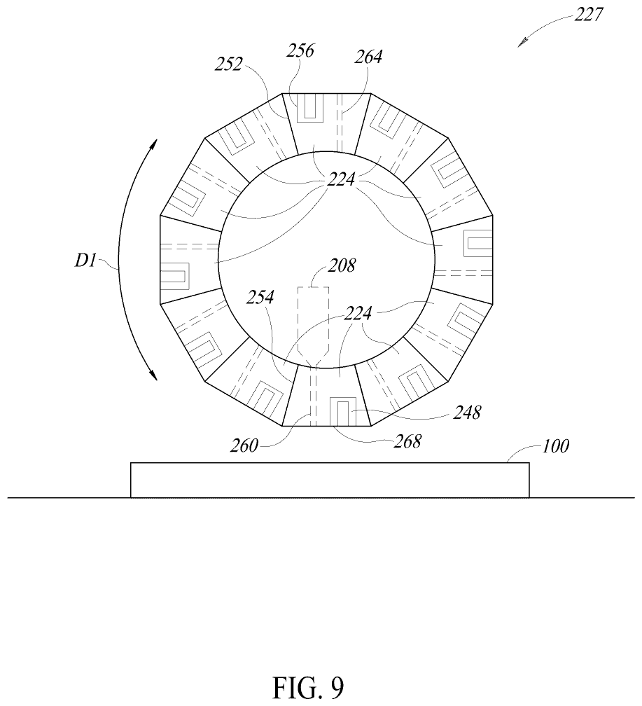

The multi-outlet turret 227, an example of which is most clearly shown in FIG. 9, may be configured to enable the panel construction machine 200 to utilize a plurality of insert holding devices 224. For example, the multi-outlet turret 227 may include a first insert holding device 254 having a first deployable pin 248 configured to grip a threaded insert 116 and may additionally include a second insert holding device 252 having a second deployable pin 256 configured to grip a through-hole insert. In some embodiments, the first and second deployable pins 248, 256 may each be configured as the same style of pin, such as pins configured to grip threaded inserts, but the first and second deployable pins 248, 256 may be configured to grip inserts of different sizes. Each of the first and second insert holding devices 252, 254 may include injection molding apertures 260, 264 configured to allow different injection molding nozzles 208 to extend therethrough. The different injection molding nozzles 208 may enable flow of the extruded plastic material 102 at different flow rates. In some embodiments, such a difference in flow rates may be accomplished by the different injection molding nozzles 208 including different nozzle diameters D3 and the first and second injection molding apertures 260, 264 of the first and second and second insert holding devices 252, 254 including respective diameters corresponding to the diameters of the different injection molding nozzles 208.

The multi-outlet turret 227 may collectively include a plurality of outlet faces 268 of different shapes, each of which may be configured to contact variously shaped panels 100. For example, a first outlet face may be flat to align with a flat face of a panel, while a second outlet face may be curved to align with a curved face of a panel. The plurality of outlet faces 268 are not limited to flat and curved shapes, but may also be stepped, notched, or any other shape.

It should be understood the multi-outlet turret 227 is not limited to two insert holding devices 224, and may include a higher number of insert holding devices 224. For example, the multi-outlet turret 227 of the example embodiment of FIG. 9 includes twelve insert holding devices 224. Additionally, each insert holding device 224 may include any combination of deployable pins 233 and injection molding apertures 237. Further, each combination of deployable pins 233 and injection molding apertures 237 may be utilized with any outlet face 268. Thus, the multi-outlet turret 227 is configured to include insert holding devices 224 having any desirable combination of deployable pins 233, injection molding apertures 237, and outlet faces 268.

The panel cutter 226 may be configured to cut through the panel 100.

During operation, the selected insert holding device 224 may be placed into a position adjacent to the panel 100 by rotation of the multi-outlet turret 227 in a rotational direction D1. The multi-outlet turret 227 may be configured such that when the selected insert holding device 224 is placed into the position adjacent to the panel 100, the insert holding device 224 is aligned with the injection molding nozzle 208, such that the extruded plastic material 102 flows through the injection molding aperture 237 of the selected insert holding device 224. When an insert 116 is to be utilized, the multi-outlet turret 227 may be configured such that when the selected insert holding device 224 is placed into the position adjacent to the panel 100, the selected insert holding device 224 receives the insert 116 from the vibratory hopper 216.

The panel construction machine 200 may be configured to receive operation directions from a controller. Such a transmission may occur via a wired connection or a wireless connection, including, but not limited to, Bluetooth, Wi-Fi, radio transmission. The controller may include at least one memory for storing instructions and at least one processor for executing the instructions stored in the memory to manufacture the panel 100 based on a selected panel manufacturing type. The panel manufacturing type may be manually selected by an operator of the panel construction machine 200, or may be selected by the controller based on detection by sensing devices of the panel construction machine 200 with regard to characteristics of the panel 100 in the machine.

In some embodiments, the controller may be configured to output a message in response to a status of the manufacturing operation. For example, upon completion of the manufacturing of the panel 100, the controller may output a completion message. In another example, if a fault occurs within the panel construction machine 200, the controller may output an error message.

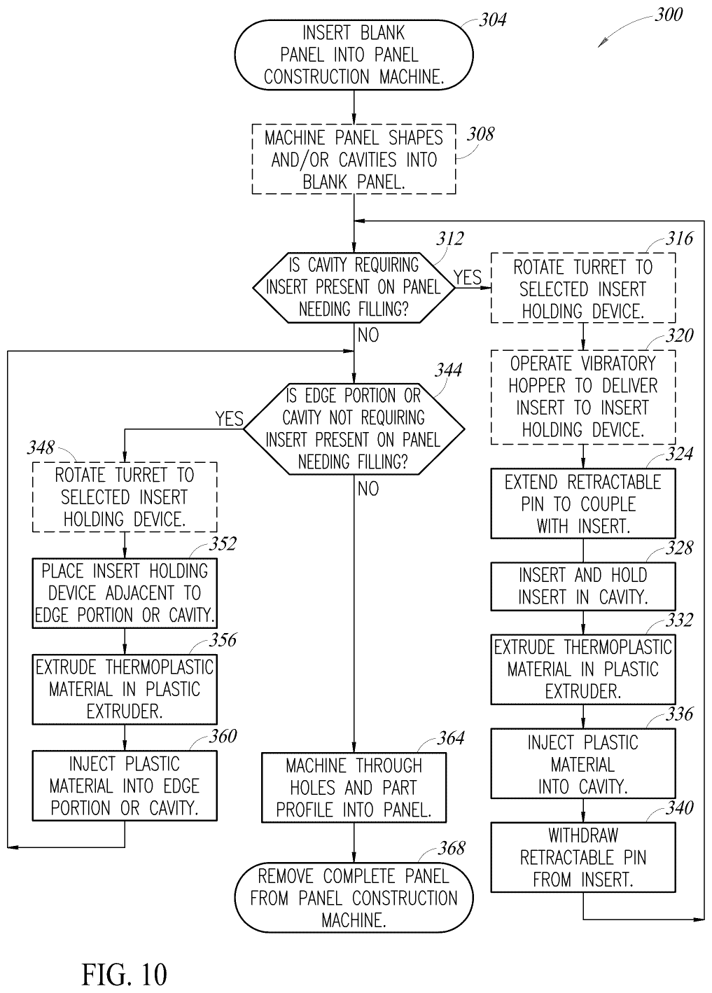

FIG. 10 shows a flow chart of a method 300 of manufacturing the panel 100, such as by using the panel construction machine 200 described in FIGS. 2-9. The method 300 begins at step 304 at which a blank panel 228 is placed in the panel construction machine 200. The method may then proceed to optional step 308, during which panel 100 shapes and/or cavities 112 are machined into the blank panel 228, which may place the panel 100 into a similar state as the panel 100 shown in FIG. 3. The optional step 308 may not occur if the blank panel 228 already includes machined cavities 112 and/or shapes.

At decision step 312, it is determined whether there is a cavity 112 present on the panel 100 which may require filling and insertion of an insert 116 therein. If it is determined at the step 312 that a cavity 112 does require filling and an insert 116 therein, the method 300 proceeds to optional step 316. At the optional step 316, the multi-outlet turret 227 may be rotated such that a selected insert holding device 224 is placed in an operational position. The step 316 may not occur when a multi-outlet turret 227 is not present (e.g., when the panel construction machine 200 includes a single insert holding device 224) or when the selected insert holding device 224 is already in the selected position.

Next, the method 300 may proceed to optional step 320. At the optional step 320, the vibratory hopper 216 may be activated to deliver the insert 116 to the insert holding device 224. The optional step 320 may be bypassed if a vibratory hopper 216 is not utilized, for example, when the inserts 116 are gravity fed.

The method 300 may then proceed to step 324, at which the deployable pin 233 is extended from the selected insert holding device 224 in order to grip the insert 116. When extending from the insert holding device 224, the deployable pin 233 may rotate, such that the threads 235 of the deployable pin 233 engage the threads 236 of the insert 116.

Next, the method 300 proceeds to step 328, by the insert holding device 224 placing and holding the insert 116 in the cavity 112. The insert holding device 224 may hold the insert 116 in the cavity 112 at a desired height, such that the insert 116 is in a desired position of the final configuration of the panel 100.

At the next step of the method 300, step 332, the plastic extruder 204 is operated to extrude the plastic material 102. Such extrusion may include receipt of the plastic nurdles in the plastic extruder 204 and compressing and heating the nurdles to create the extruded plastic material 102. Such extrusion may occur by way of a screw extrusion process. It should be understood that the step 332 may occur simultaneously to or before any of the above described steps, so long as the extruded plastic material 102 is not injected through the injection molding nozzle 208 prior to the next step, step 336.

At the step 336, the extruded plastic material 102 is injected into the cavity 112. The extruded plastic material 102 may flow from the injection molding nozzle 208 and to the cavity 112. Prior to the injecting of the extruded plastic material 102, the injection molding nozzle 208 may be lowered to a desired depth. For example, the injection molding nozzle 208 may move from the position shown in FIG. 4 to the position shown in FIG. 5.

During injection of the step 336, the extruded plastic material 102 surrounds the insert 116 held by the insert holding device 224. The extruded plastic material 102 pots the insert 116 in the cavity 112 as the extruded plastic material 102 is injected into the cavity 112. The deployable pin 233 continues to grip the insert 116 in place during injection of the extruded plastic material 102 of the step 336. As the extruded plastic material 102 is injected in the cavity 112 around the insert 116, the injection molding nozzle 208 may be withdrawn from the cavity 112 to fill the cavity 112 with the extruded plastic material 102. For example, the injection molding nozzle 208 may be withdrawn from the position shown in FIG. 5 to the position in FIG. 6. Additionally or alternatively, the injection molding nozzle 208 may be repositioned to inject extruded plastic material 102 on a different side of the insert 116. In some embodiments, an additional injection molding nozzle may inject extruded plastic material 102 into a different side of the insert 116.

Following completion of injection of the extruded plastic material 102, the method proceeds to step 340, at which the deployable pin 233 releases the insert 116 and is withdrawn into the insert holding device 224. The withdrawal of the step 340 may include rotation of the deployable pin 233 to decouple the deployable pin 233 from the insert 116.

Following the step 340, the method 300 returns to the step 312 to determine if further cavities 112 require filling. If further cavities require filling, the steps 316-340 repeat for the subsequent cavity.

If no further cavities require filling at the step 312, the method 300 proceeds to decision step 344.

At the step 344, it is determined whether there is an edge portion 120 or a cavity 112 not requiring an insert 116 is present on the panel 100 which requires filling. If it is determined at the step 344 that there is an edge portion 120 or a cavity 112 not requiring an insert 116 requiring filling, the method 300 may proceed to optional step 348. At the optional step 348, the multi-outlet turret 227 may be rotated such that a selected insert holding device 224 is placed in an operational position. The step 348 may not occur when a multi-outlet turret 227 is not present (e.g., when the panel construction machine 200 includes a single insert holding device 224) or when the selected insert holding device 224 is already in the selected position. It should be noted that deployable pin 233 of the selected insert holding device 224 will not be utilized in the step 348, as no inserts will be installed into the relevant edge portion 120 or cavity 112. In such operations, the selected insert holding device 224 may not include a deployable pin 233 and/or an injection molding aperture 237. In other words, the selected insert holding device 224 may enable use of an injection molding nozzle 208 independent of the insert holding device 224.

Next, the method 300 proceeds to optional step 352 when an insert holding device 224 is to be utilized, at which the selected insert holding device 224 is positioned adjacent to (e.g., above) the edge portion 120 to be filled. The optional step 352 may be bypassed when the injection molding nozzle 208 is used independent of the insert holding device 224.

At the next step of the method 300, step 356, the plastic extruder 204 is operated to extrude the plastic material 102. Such extrusion may include receipt of the plastic nurdles in the plastic extruder 204 and compressing and heating the nurdles to create the extruded plastic material 102. Such extrusion may occur by way of a screw extrusion process. It should be understood that the step 356 may occur simultaneously to or before any of the above described steps, so long as the extruded plastic material 102 is not injected through the injection molding nozzle 208 into the edge portion 120 or the cavity 112 prior to positioning of the insert holding device 224 of the step 352.

At the next step, step 360, the extruded plastic material 102 is injected into the edge portion 120 or the cavity 112. The extruded plastic material 102 may flow from the injection molding nozzle 208 and to the edge portion 120 or cavity 112. Prior to the injecting of the extruded plastic material 102, the injection molding nozzle 208 may be lowered to a desired depth. For example, the injection molding nozzle 208 may move from the position shown in FIG. 7 to the position shown in FIG. 8. During injection of the step 360, the extruded plastic material 102 fills the edge portion 120 or cavity 112. As the extruded plastic material 102 fills the edge portion 120 or cavity 112, the injection molding nozzle 208 may be withdrawn from the edge portion 120 or cavity 112, such that the extruded plastic material 102 is disposed at different depths of the edge portion 120 or cavity 112. The injection molding nozzle 208 may be moved along the edge portion 120 or cavity 112 during the step 360 to enable filling of the entirety of the edge portion 120 or cavity 112.

It should be understood that any of steps 348-360 may be completed with an insert holding device 224 not including a deployable pin 233.

Following filling of the edge portion 120 or cavity 112 with the extruded plastic material 102, the method returns to the step 344 to determine if further edge portions 120 or cavities 112 not requiring inserts require filling. If further edge portions 120 or cavities 112 not requiring inserts 116 require filling, the steps 348-360 repeat for the subsequent edge portion 120 or cavity 112.

If no further edge portions 120 or cavities 112 require filling at the step 344, the method 300 may proceed to optional step 364.

At the optional step 364, further machining of the panel 100 may occur. Such machining may include, but is not limited to, machining through holes (e.g., through filled cavities 112 at the step 360) and defining panel 100 profiles. The machining of the step 364 may include machining the extruded plastic material 102 to desired dimensions. For example, the machining of step 364 may include machining the extruded plastic material 102 to include a smooth surface.

The method 300 ends at step 368, at which the completed panel 100 is removed from the panel construction machine 200.

In some embodiments, the panel 100 may not move within the panel construction machine 200 during the method 300. Alternatively, in some embodiments, the panel may move within the panel construction machine 200 during the method 300.

The method 300 may be controlled by operation of the controller. More specifically, the operation of the controller described above in method 300 may be executed by a processor of the controller.

The panel construction system and associated methods and panels described herein may be adapted to a variety of different pieces of equipment. Such a panel construction system and associated methods may provide an improved manufacturing solution when manufacturing a panel of a vehicle, specifically with regard to the time to manufacture such a panel. Such a panel construction system may also reduce the flammability of the manufactured panels due to the use of thermoplastic materials in place of various resins. Additionally, the panel construction system and associated panels enable multiple panels to be coupled without the use of fixtures, due to the panels being capable of directly receiving fasteners in the installed inserts.

The devices and systems of the disclosure each have several innovative aspects, no single one of which is solely responsible or required for the desirable attributes disclosed herein. The various features described above may be used independently of one another, or may be combined in various ways. All possible combinations and subcombinations are intended to fall within the scope of this disclosure. Various modifications to the implementations described in this disclosure may be readily apparent to those of ordinary skill in the art, and the generic principles defined herein may be applied to other implementations. Thus, the claims are not intended to be limited to the implementations shown herein, but are to be accorded the widest scope consistent with this disclosure, the principles and the novel features disclosed herein.

Certain features that may be described in this specification in the context of separate implementations also may be implemented in combination in a single implementation. Conversely, various features that may be described in the context of a single implementation also may be implemented in multiple implementations separately or in any suitable subcombination. Moreover, although features may be described above as acting in certain combinations and even initially claimed as such, one or more features from a claimed combination can be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

In general, in the following claims, the terms used should not be construed to limit the claims to the specific embodiments disclosed in the specification and the claims, but should be construed to include all possible embodiments along with the full scope of equivalents to which such claims are entitled.

1. A method of manufacturing a panel, comprising:
extruding a plastic material; and
injecting the extruded plastic material into at least one of:
an edge of the panel; and
an insert cavity of the panel.

2. The method of claim 1, wherein the extruded plastic material surrounds an insert in the insert cavity and the insert is potted in the panel by the extruded plastic material when the extruded plastic material is injected into the insert cavity of the panel.

3. The method of claim 2, further comprising releasably gripping the insert during injecting of the extruded plastic material into the insert cavity of the panel.

4. The method of claim 3, wherein the insert is releasably gripped on an interior face of the insert.

5. The method of claim 3, wherein the insert is removably gripped by a deployable pin,
wherein the deployable pin extends from a pin housing and grips the insert prior to injection of the extruded plastic material into the insert cavity of the panel, and
wherein the deployable pin releases the grip on the insert following completion of the injection of the extruded plastic material into the insert cavity and retracts to the pin housing.

6. The method of claim 5, wherein the deployable pin comprises external threads configured to threadably couple to internal threads of the insert when the deployable pin grips the insert.

7. The method of claim 3, wherein the insert is releasably gripped such that the insert does not extend through an entirety of the insert cavity.

8. The method of claim 1, wherein the edge of the panel is defined by a machining device prior to injection of the extruded plastic material onto the edge of the panel.

9. The method of claim 1, wherein the insert cavity is machined into the panel prior to injection of the extruded plastic material into the insert cavity of the panel.

10. The method of claim 1, wherein a shape profile of the panel is defined by a machining device following injection of the extruded plastic material onto the edge of the panel.

11. The method of claim 1, wherein the extruding of the plastic material occurs via screw extrusion of thermoplastic nurdles.

12. The method of claim 1, wherein the method is performed on a single machine.

13. A panel construction machine, comprising:
a plastic extruder configured to extrude a plastic material; and
an injection molding nozzle configured to inject the extruded plastic material into at least one of:
an edge of a panel; and
an insert cavity of the panel.

14. The panel construction machine of claim 13, wherein the injection molding nozzle is configured to inject the extruded plastic material into the insert cavity of the panel when an insert is present in the insert cavity.

15. The panel construction machine of claim 14, further comprising a pin configured to releasably grip the insert during injection of the extruded plastic material into the insert cavity of the panel.

16. The panel construction machine of claim 15, wherein the pin is configured to grip an internal face of the insert.

17. The panel construction machine of claim 16, wherein the pin includes external threads configured to threadably couple to internal threads of the insert.

18. The panel construction machine of claim 15, wherein the pin is configured to selectively extend from an insert holding device, the insert holding device including an injection molding aperture configured such that the injection molding nozzle passes through the injection molding aperture prior to injection of the extruded plastic material within the insert cavity.

19. The panel construction machine of claim 18, further comprising a turret having a plurality of insert holding devices.

20. The panel construction system of claim 19, wherein the plurality of insert holding devices is configured to collectively hold a plurality of inserts.

21. The panel construction machine of claim 15, further comprising a vibratory hopper configured to hold the inserts and to deliver the inserts to the pin.

22. The panel construction machine of claim 13, further comprising a machining device configured to machine the panel.

23. The panel construction machine of claim 13, wherein the plastic extruder is a screw extruder.

24. The panel construction machine of claim 13, further comprising a hopper configured to hold thermoplastic nurdles, the thermoplastic nurdles comprising the plastic material, wherein the plastic extruder is configured to receive the thermoplastic nurdles from the hopper.

25. A panel comprising an extruded plastic material present in at least one of an edge of the panel and an insert cavity of the panel, wherein the panel is manufactured by a process comprising:
extruding the plastic material; and
injecting the extruded plastic material into at least one of:
the edge of the panel; and
the insert cavity of the panel.
